(19) United States
(12) Patent Application Publication
(10) Pub. No.: US 2019/0155873 A1
(43) Pub. Date: May 23, 2019

(54) DOCUMENT PROCESSING APPARATUS AND NON-TRANSITORY COMPUTER READABLE MEDIUM STORING PROGRAM

(71) Applicant: FUJI XEROX CO., LTD., Tokyo (JP)

(72) Inventors: Satoshi KONDO, Kanagawa (JP); Kiyoshi TAKAHASHI, Kanagawa (JP)

(73) Assignee: FUJI XEROX CO., LTD., Tokyo (JP)

(21) Appl. No.: 16/178,755

(22) Filed: Nov. 2, 2018

(30) Foreign Application Priority Data
Nov. 17, 2017 (JP) 2017-222149

(51) Int. Cl. G06F 17/21; G06F 17/30

(52) U.S. Cl. CPC G06F 17/218; G06F 17/30011; G06F 17/30203; G06F 17/30126

(57) ABSTRACT

A document processing apparatus includes an acquisition unit that acquires an electronic document from an external storage apparatus, an addition unit that adds attribute information to the electronic document acquired by the acquisition unit, and a storage unit that stores the electronic document having the attribute information added thereto by the addition unit in a storage destination in the external storage apparatus.

### CROSS-REFERENCE TO RELATED APPLICATIONS

This application is based on and claims priority under 35 USC 119 from Japanese Patent Application No. 2017-222149 filed Nov. 17, 2017.

### BACKGROUND

### Technical Field

The present invention relates to a document processing apparatus and a non-transitory computer readable medium storing a program.

### SUMMARY

According to an aspect of the invention, there is provided a document processing apparatus including an acquisition unit that acquires an electronic document from an external storage apparatus, an addition unit that adds attribute information to the electronic document acquired by the acquisition unit, and a storage unit that stores the electronic document having the attribute information added thereto by the addition unit in a storage destination in the external storage apparatus.

### BRIEF DESCRIPTION OF THE DRAWINGS

Exemplary embodiments of the present invention will be described in detail based on the following figures, wherein:

FIG. 1 illustrates the system configuration of a document management system of a first exemplary embodiment of the present invention;

FIG. 2 is a block diagram illustrating the hardware configuration of a document processing apparatus in the first exemplary embodiment of the present invention;

FIG. 3 is a block diagram illustrating the functional configuration of the document processing apparatus in the first exemplary embodiment of the present invention;

FIG. 4 is a flowchart for illustrating processing in which the document processing apparatus acquires an electronic document file, adds attribute information, and then stores the electronic document file again in a specified storage area;

FIG. 5 illustrates an example of a display screen when one electronic document out of an acquired electronic document file group is displayed;

FIG. 6 illustrates screen contents displayed when a user completes an input of attribute information and depresses a “register” button in the example of the display screen illustrated in FIG. 5;

FIG. 7 illustrates screen contents displayed when the user selects an “associated folder” and depresses an “OK” button in the display screen illustrated in FIG. 6;

FIG. 8 illustrates an example of electronic documents stored in a root folder of a document management server;

FIG. 9 illustrates a state in which pieces of attribute information are added to the electronic documents stored in the root folder of the document management server as illustrated in FIG. 8, a different document management server is specified as a storage destination, and the electronic documents are stored in the specified document management server;

FIGS. 10A to 10C illustrate combination patterns of a document management server of an acquisition source and a document management server of a storage destination;

FIG. 11 illustrates an example of storage destination information stored in a data storage part in a second exemplary embodiment of the present invention;

FIG. 12 illustrates another example of the storage destination information stored in the data storage part in the second exemplary embodiment of the present invention;

FIG. 13 is a flowchart for illustrating processing in which a document processing apparatus in a document management system of the second exemplary embodiment of the present invention acquires an electronic document file, adds attribute information, and then stores the electronic document file again in a specified storage area; and

FIG. 14 illustrates a state in which an electronic document having attribute information added thereto is stored again in a storage destination determined based on set storage destination information.

### DETAILED DESCRIPTION

Exemplary embodiments of the present invention are described in detail with reference to the drawings.

### First Exemplary Embodiment

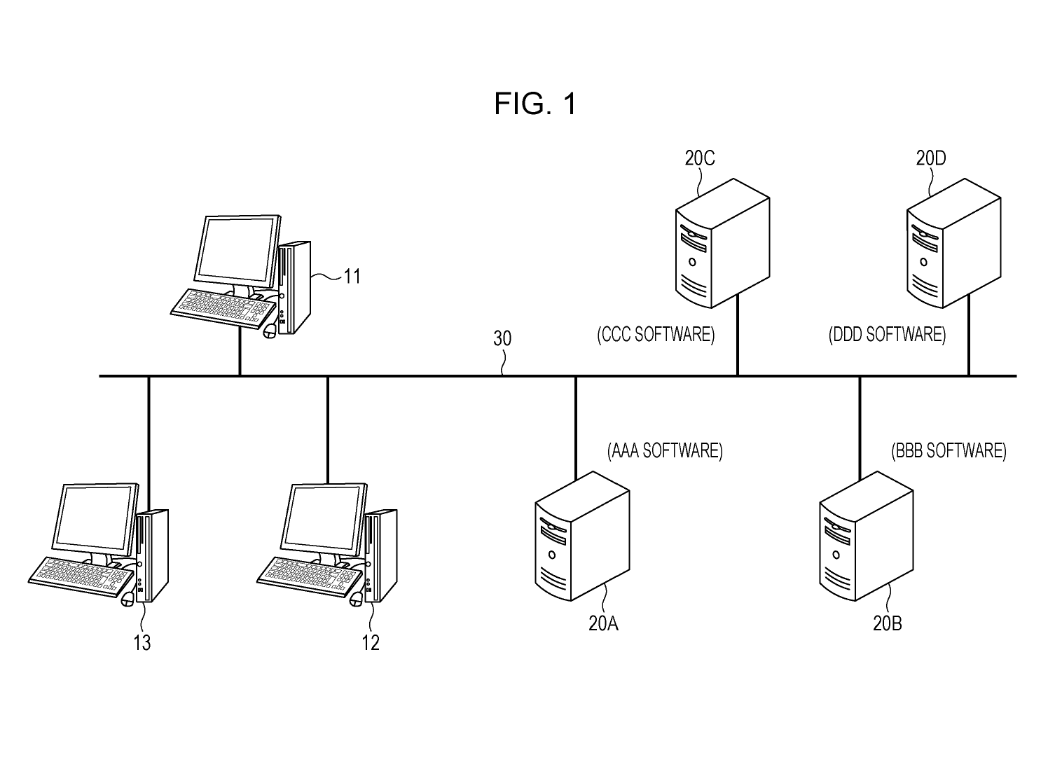

FIG. 1 illustrates the system configuration of a document management system of a first exemplary embodiment of the present invention.

As illustrated in FIG. 1, the document management system of the first exemplary embodiment of the present invention is configured by document processing apparatuses 11 to 13 such as personal computers and document management servers 20A to 20D that are connected to each other via a network 30.

There are various types of document management software for editing or creating an electronic document file (hereinafter referred to simply as an electronic document). For example, the following description is made under the assumption that there are four types of document management software that are AAA software, BBB software, CCC software, and DDD software.

The document management servers 20A to 20D store electronic documents generated by the different types of document management software that are the AAA software, the BBB software, the CCC software, and the DDD software, respectively.

Those types of document management software call a function at a determined timing by using a dynamic link library (DLL) file having a defined interface. Therefore, the plural and different types of document management software are associable with each other.

A certain type of document management software such as the AAA software is installed in each of the document processing apparatuses 11 to 13. With the document management software that is the AAA software, an electronic document file may be edited or created.

The same document management software that is the AAA software is installed in each of the document processing apparatuses 11 to 13. Thus, generated electronic documents may be transmitted, received, viewed, or revised.

The document management server 20A is connected to the document processing apparatuses 11 to 13 via the network 30 and stores electronic documents generated by the document processing apparatuses 11 to 13. Users who use the document processing apparatuses 11 to 13 view the electronic documents stored in the document management server 20A or store generated electronic documents in the document management server 20A. Thus, the electronic documents may be exchanged or used among the document processing apparatuses 11 to 13.

The document management software described above includes attribute adding software for adding attribute information to an electronic document. The attribute adding software has a function of adding various types of attribute information such as a document type to an electronic document and storing the electronic document having the attribute information added thereto while categorizing the electronic document based on the added attribute information. The attribute adding software and the document management software for viewing electronic documents are also associated with each other by using the DLL file described above.

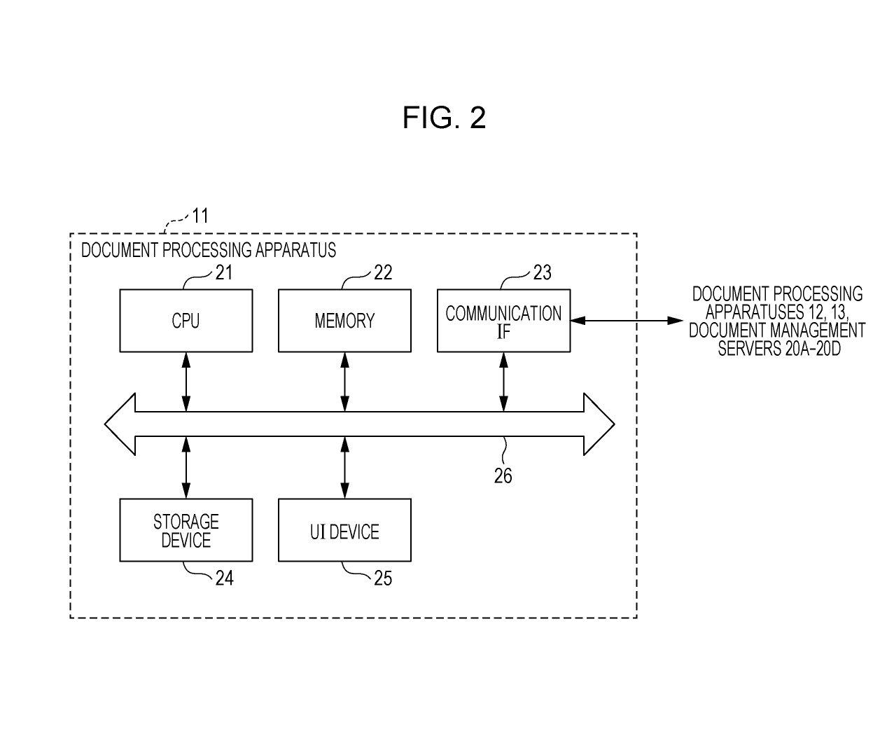

FIG. 2 illustrates the hardware configuration of the document processing apparatus 11 in the document management system of this exemplary embodiment. The configurations of the document processing apparatuses 12 and 13 are identical to the configuration of the document processing apparatus 11 and description thereof is therefore omitted.

As illustrated in FIG. 2, the document processing apparatus 11 includes a CPU 21, a memory 22, a communication interface (IF) 23 that transmits and receives data to and from external apparatuses and the like via the network 30, a storage device 24 such as a hard disk drive (HDD), and a user interface (UI) device 25 including a touch panel or a liquid crystal display and a keyboard. Those components are connected to each other via a control bus 26.

The CPU 21 controls an operation of the document processing apparatus 11 by executing predetermined processing based on a control program stored in the memory 22 or the storage device 24. This exemplary embodiment is described under the assumption that the CPU 21 reads and executes the control program stored in the memory 22 or the storage device 24. The program may be provided to the CPU 21 by being stored in a storage medium such as a CD-ROM.

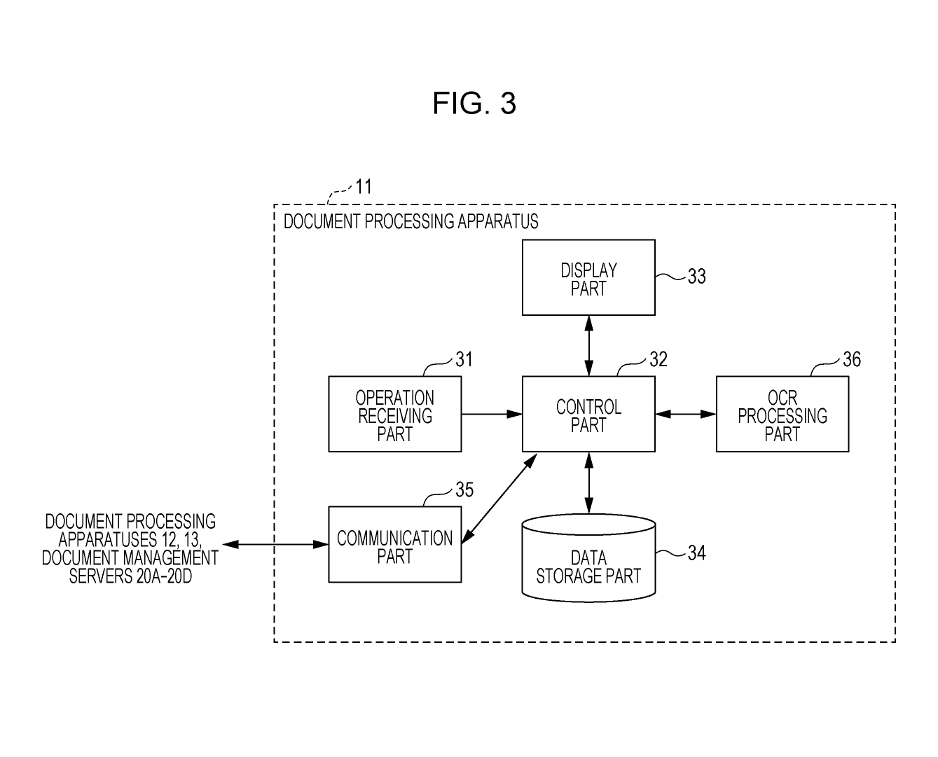

FIG. 3 is a block diagram illustrating the functional configuration of the document processing apparatus 11 that is implemented by executing the control program described above.

As illustrated in FIG. 3, the document processing apparatus 11 includes an operation receiving part 31, a control part 32, a display part 33, a data storage part 34, a communication part 35, and an optical character reader (OCR) processing part 36.

The operation receiving part 31 receives an input of character information to be added to an electronic document as attribute information. When the character information to be added to the electronic document as the attribute information is input, the operation receiving part 31 receives specification of a storage destination of the electronic document having the attribute information added thereto.

When any area is specified in the displayed electronic document, the OCR processing part 36 performs the OCR processing (character recognition processing) on the specified area, thereby acquiring, from the electronic document, character information located in the specified area.

The control part 32 acquires electronic documents from the document management servers 20A to 20D that are external storage apparatuses by accessing the document management servers 20A to 20D via the communication part 35.

Then, the control part 32 adds attribute information to each of the acquired electronic documents. Specifically, the control part 32 adds character information acquired by the OCR processing part 36 or character information input by the user to each of the electronic documents as the attribute information.

Finally, the control part 32 stores the electronic documents each having the attribute information added thereto in storage destinations in the document management servers 20A to 20D that are the external storage apparatuses.

At this time, the control part 32 stores the electronic document having the attribute information added thereto in a document management server that is specified as the storage destination of the electronic document among the document management servers 20A to 20D. The specification of the document management server is received by the operation receiving part 31.

When storage destination information indicating a storage destination corresponding to attribute information is stored in advance in the data storage part 34, the control part 32 stores the electronic document having the attribute information added thereto in a storage destination in an external storage apparatus specified based on the storage destination information corresponding to the attribute information, that is, any one document management server out of the document management servers 20A to 20D.

The storage destination information stored in the data storage part 34 may include not only information indicating an external storage apparatus of a storage destination but also information indicating an external storage apparatus of a storage destination and a storage area in the external storage apparatus. In this case, the control part 32 stores the electronic document having the attribute information added thereto in the specified storage area in the external storage apparatus specified as the storage destination by the storage destination information.

Through the control described above, the external storage apparatus of an acquisition source from which an electronic document is acquired may be different from the external storage apparatus of the storage destination in which the electronic document is stored by the control part 32. Further, the external storage apparatus of the acquisition source from which an electronic document is acquired may be identical to the external storage apparatus of the storage destination in which the electronic document is stored by the control part 32.

When the external storage apparatus of the acquisition source is identical to the external storage apparatus of the storage destination, the electronic document having the attribute information added thereto may be stored in a storage area identical to a storage area from which the electronic document is acquired or in a storage area different from the storage area from which the electronic document is acquired.

As the case in which the electronic document having the attribute information added thereto is stored in the storage area different from the storage area from which the electronic document is acquired, there is a case in which the control part 32 generates a new storage area in a lower-level layer of the storage area from which the electronic document is acquired and stores the electronic document having the attribute information added thereto in the generated new storage area.

When a new storage area is generated in the lower-level layer of the storage area from which the electronic document is acquired and the electronic document is stored, the control part 32 may generate plural new storage areas corresponding to pieces of attribute information in the lower-level layer of the storage area from which the electronic document is acquired and store the electronic document having the attribute information added thereto in any one storage area out of the plural generated new storage areas based on the added attribute information.

The display part 33 displays an electronic document and various types of information for the user based on control of the control part 32. The communication part 35 transmits and receives data to and from the document processing apparatuses 12 and 13, the document management servers 20A to 20D, and the like via the network 30. The data storage part 34 stores an electronic document acquired by the control part 32 and other data.

Next, an operation of the document processing apparatus 11 in the document management system of this exemplary embodiment is described in detail with reference to the drawings.

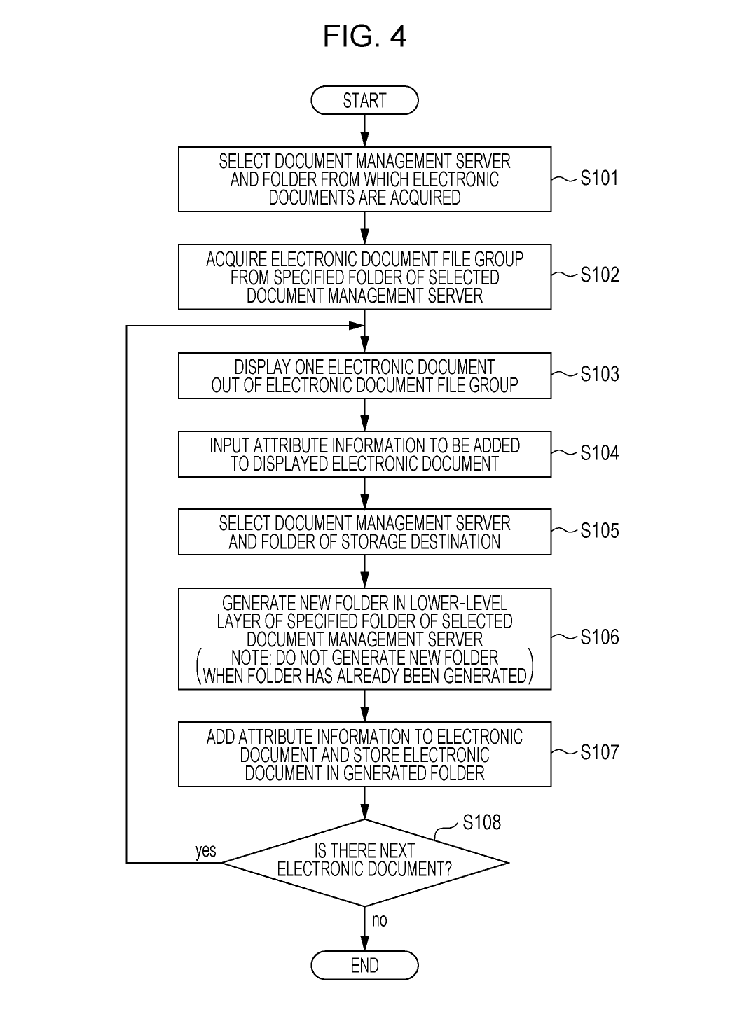

FIG. 4 is a flowchart for illustrating processing in which the document processing apparatus 11 acquires an electronic document file, adds attribute information, and then stores the electronic document file again in a specified storage area.

When the user selects, via the operation receiving part 31, a document management server (external storage apparatus) and a folder from which electronic documents are acquired (Step S101), the control part 32 acquires an electronic document file group from the specified folder of the selected document management server (Step S102).

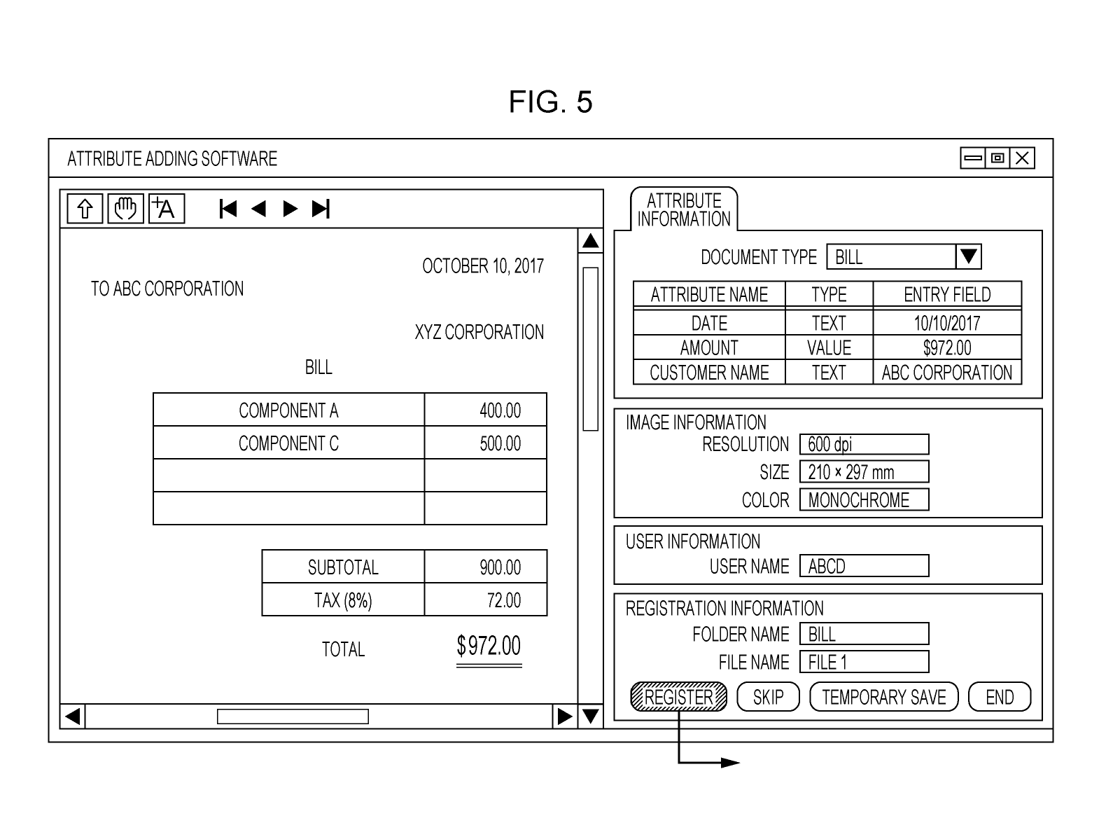

Then, the control part 32 causes the display part 33 to display one electronic document out of the acquired electronic document file group (Step S103). FIG. 5 illustrates an example of the electronic document displayed in this manner.

FIG. 5 illustrates an example of a display screen when the acquired electronic document is displayed as a preview by the attribute adding software and character information to be added to the electronic document as attribute information is input.

When the user refers to the electronic document displayed in this manner and inputs the character information to be added to the electronic document as the attribute information, the operation receiving part 31 receives the input character information (Step S104). The exemplary display screen illustrated in FIG. 5 indicates a case in which character information “bill” is selected as attribute information on a document type, information “10/10/2017” is input as attribute information whose attribute name is “date”, information “$972.00” is input as attribute information whose attribute name is “amount”, and information “ABC Corporation” is input as attribute information whose attribute name is “customer name”.

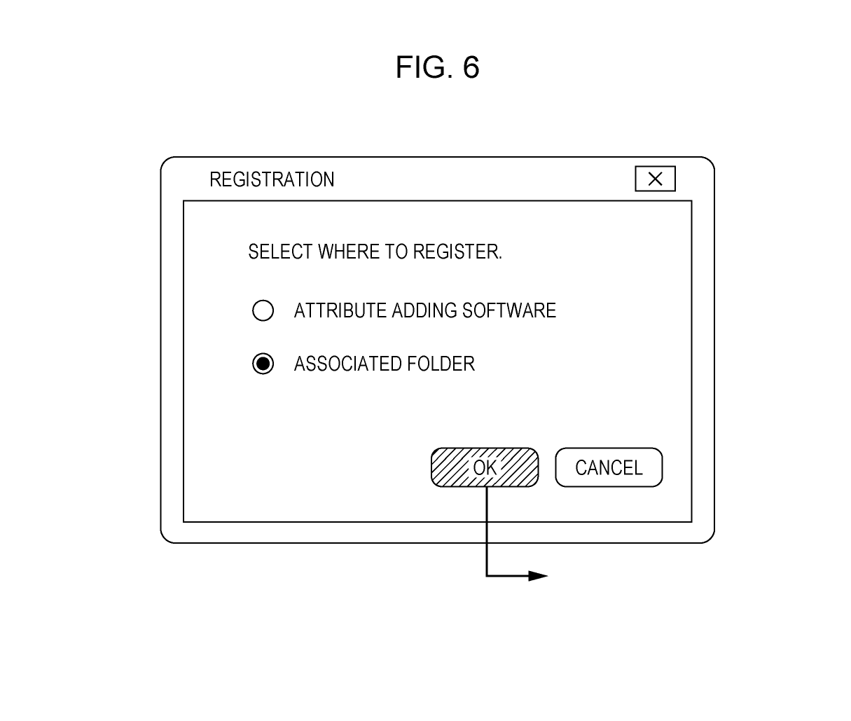

When the user completes the input of the attribute information and depresses a “register” button in the example of the display screen illustrated in FIG. 5, screen contents are displayed as illustrated in FIG. 6. In the example of the display screen illustrated in FIG. 6, the document management server of the acquisition source or another document management server that corresponds to other document management software and is different from the acquisition source may be selected as a registration destination of the electronic document having the attribute information added thereto. That is, when the “attribute adding software” is selected in the display screen illustrated in FIG. 6, the document management server of the acquisition source is directly specified as the storage destination. When an “associated folder” is selected, a document management server of other document management software associated with the document management software on which the user is currently viewing the electronic document is specified as the storage destination.

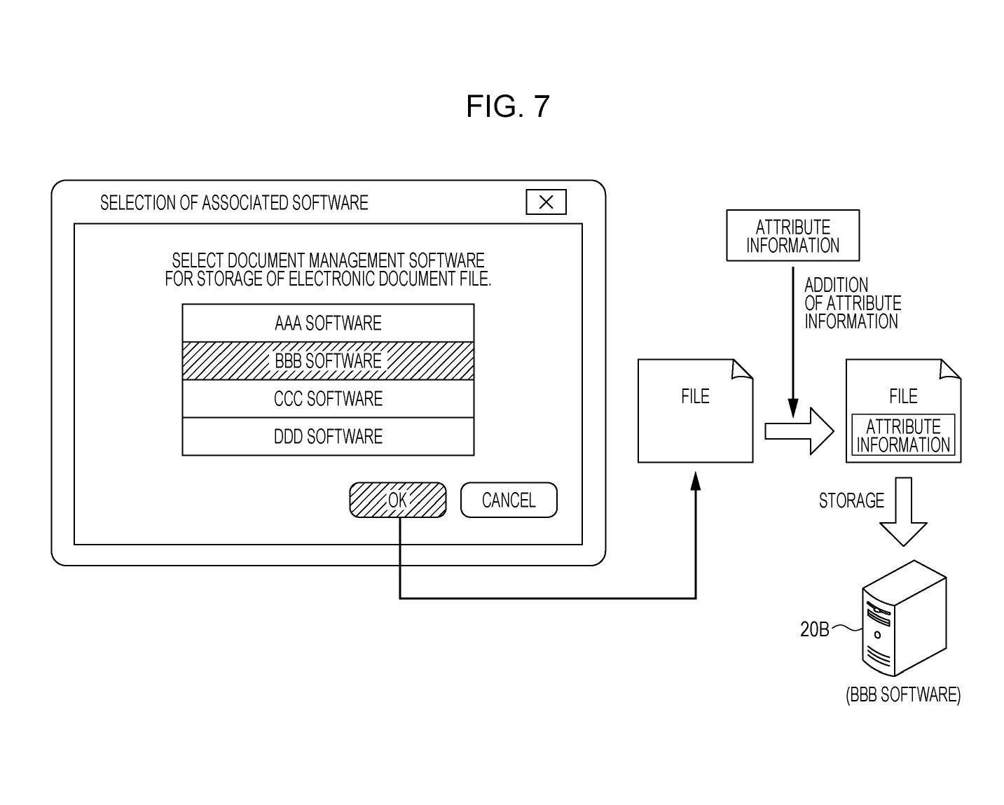

Description is herein made under the assumption that the user selects the “associated folder” and depresses an “OK” button in the display screen illustrated in FIG. 6. Next, screen contents are displayed as illustrated in FIG. 7. In the example of the display screen illustrated in FIG. 7, document management software for storing the electronic document having the attribute information added thereto is selected.

The display screen illustrated in FIG. 7 indicates a case in which the user selects the “BBB software” and depresses an “OK” button. Through the selection, the electronic document having the attribute information added thereto is stored in the document management server 20B corresponding to the BBB software (Step S105). In this case, the folder of the storage destination is not specified. Therefore, selection is made such that the electronic document is stored in a root folder that is a highest-level layer.

When the user depresses the “OK” button in the display screen illustrated in FIG. 7, a new folder is generated in a lower-level layer of the root folder of the document management server 20B that is the selected storage destination (Step S106). The attribute information is added to the electronic document and then the electronic document is stored in the generated new folder (Step S107).

In Step S106, the new folder is generated only when the first electronic document of the electronic document file group is stored. The new folder is not generated when the new folder has already been generated.

Then, the processing of Steps S103 to S107 is repeated until the processing is executed on all the electronic documents of the specified electronic document file group. When pieces of attribute information have been added to all the electronic documents and the electronic documents have been stored again in specified storage areas, the processing is terminated (Step S108).

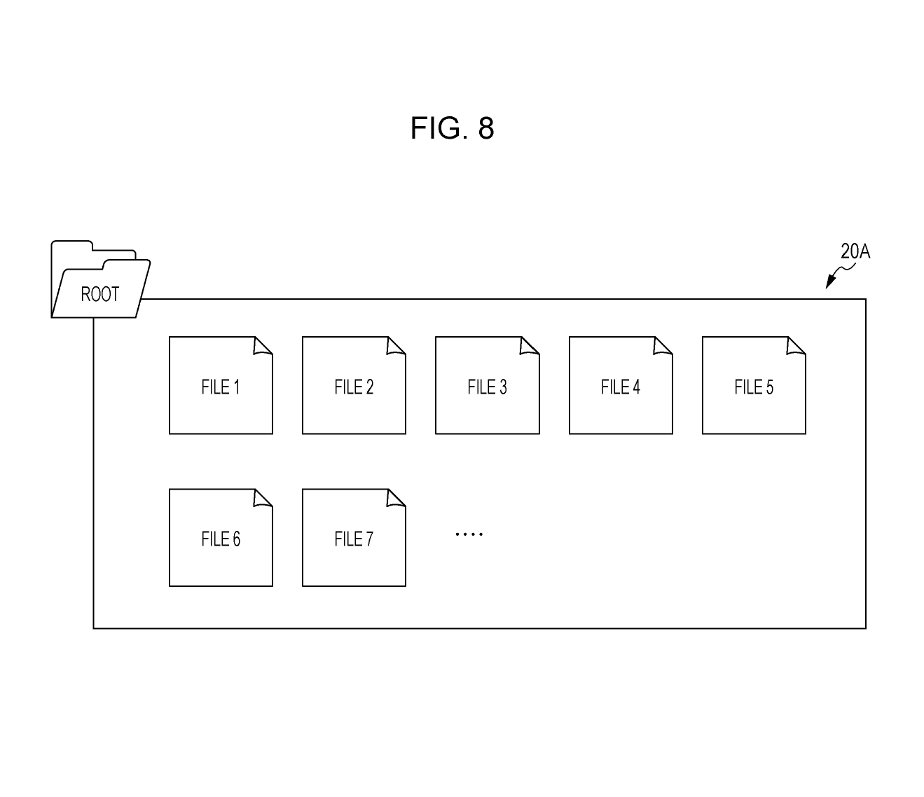

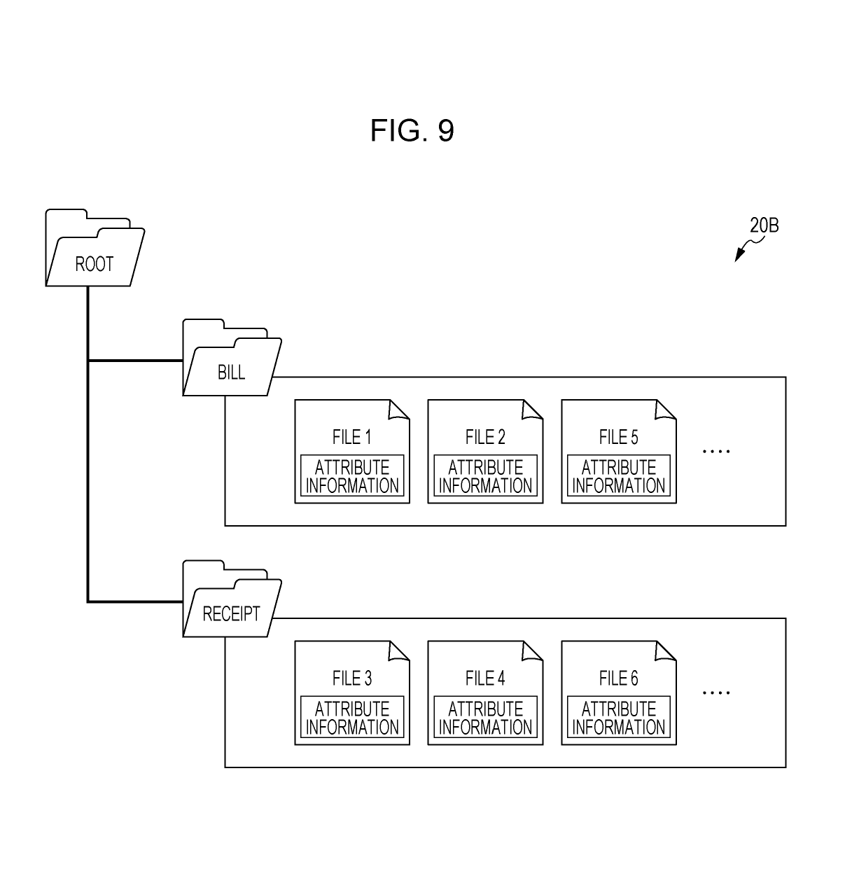

FIG. 9 illustrates a state in which pieces of attribute information are added to electronic documents (File 1, File 2, . . . ) stored in a root folder of the document management server 20A as illustrated in, for example, FIG. 8, the document management server 20B is specified as the storage destination, and the electronic documents are stored in the document management server 20B. Through the processing described above, the electronic documents each having the attribute information added thereto are stored in ‘bill’ and ‘receipt’ folders that are newly generated in the lower-level layer of the root folder of the document management server 20B.

FIG. 9 illustrates a case in which character information “bill” is added to Files 1, 2, and 5 as attribute information on the document type and character information “receipt” is added to Files 3, 4, and 6 as attribute information on the document type. The plural electronic documents each having the attribute information added thereto in this manner are categorized and stored in the folders corresponding to the pieces of added attribute information. Thus, the user does not need to separately execute two types of processing that are addition of attribute information and categorization of electronic documents each having the attribute information added thereto.

The above description is directed to the case in which the electronic documents stored in the document management server 20A are acquired and are stored again in the document management server 20B that is set as the storage destination. The document management server of the acquisition source and the document management server of the storage destination may be combined arbitrarily.

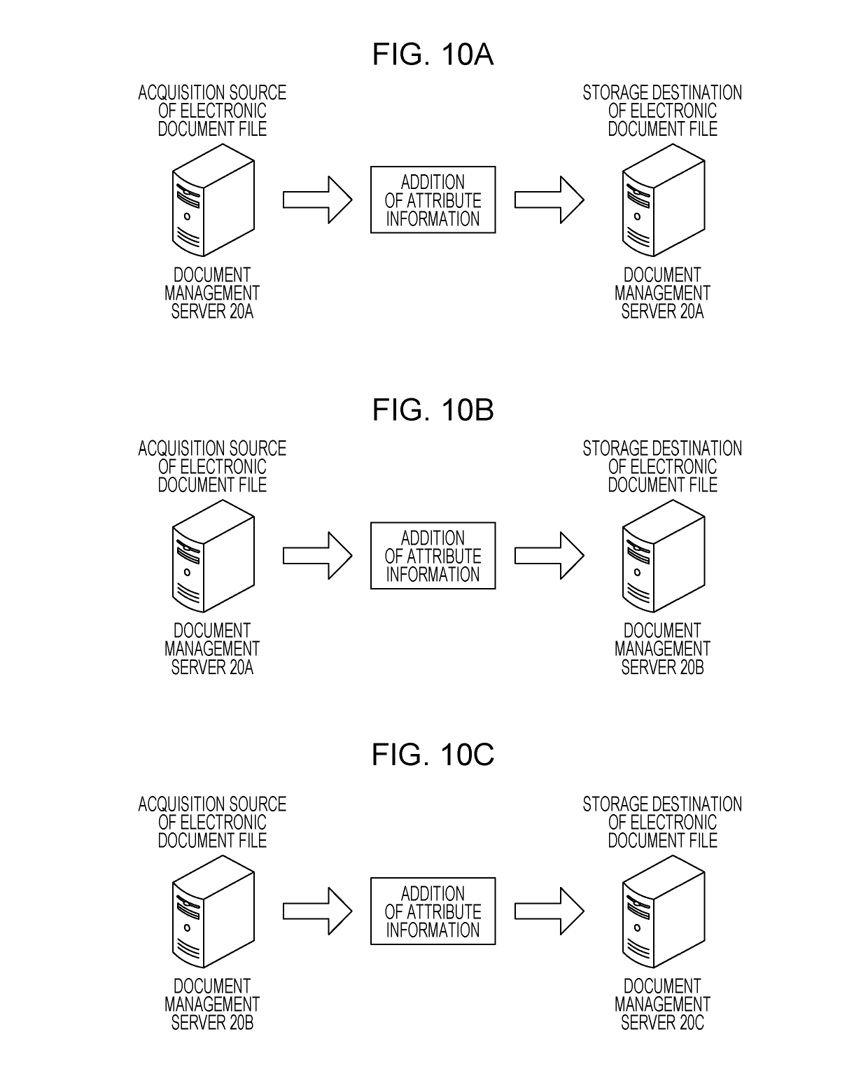

For example, as illustrated in FIG. 10A, attribute information may be added to an electronic document acquired from the document management server 20A and then the electronic document may be stored again in the document management server 20A of the acquisition source that is also set as the storage destination. As the case that is also described above, as illustrated in FIG. 10B, attribute information may be added to an electronic document acquired from the document management server 20A and then the electronic document may be stored again in the document management server 20B that is different from the document management server 20A of the acquisition source and is set as the storage destination. As illustrated in FIG. 10C, attribute information may be added to an electronic document acquired from the document management server 20B and then the electronic document may be stored again in the document management server 20C that is different from the document management server 20B of the acquisition source and is set as the storage destination.

### Second Exemplary Embodiment

Next, a document management system of a second exemplary embodiment of the present invention is described.

In the document management system of the first exemplary embodiment described above, the user specifies a storage destination and a storage area of an electronic document having attribute information added thereto. In the document management system of this exemplary embodiment, storage destination information in which a storage destination is set so as to correspond to attribute information on the document type or the like is registered in advance. Thus, there is no need to perform such an operation that the user specifies a storage destination every time attribute information is added to an electronic document.

The configurations of the document processing apparatuses 11 to 13 and the configurations of the document management servers 20A to 20D in the document management system of this exemplary embodiment are similar to those in the document management system of the first exemplary embodiment. Therefore, description is made with reference to the same reference numerals for the same components.

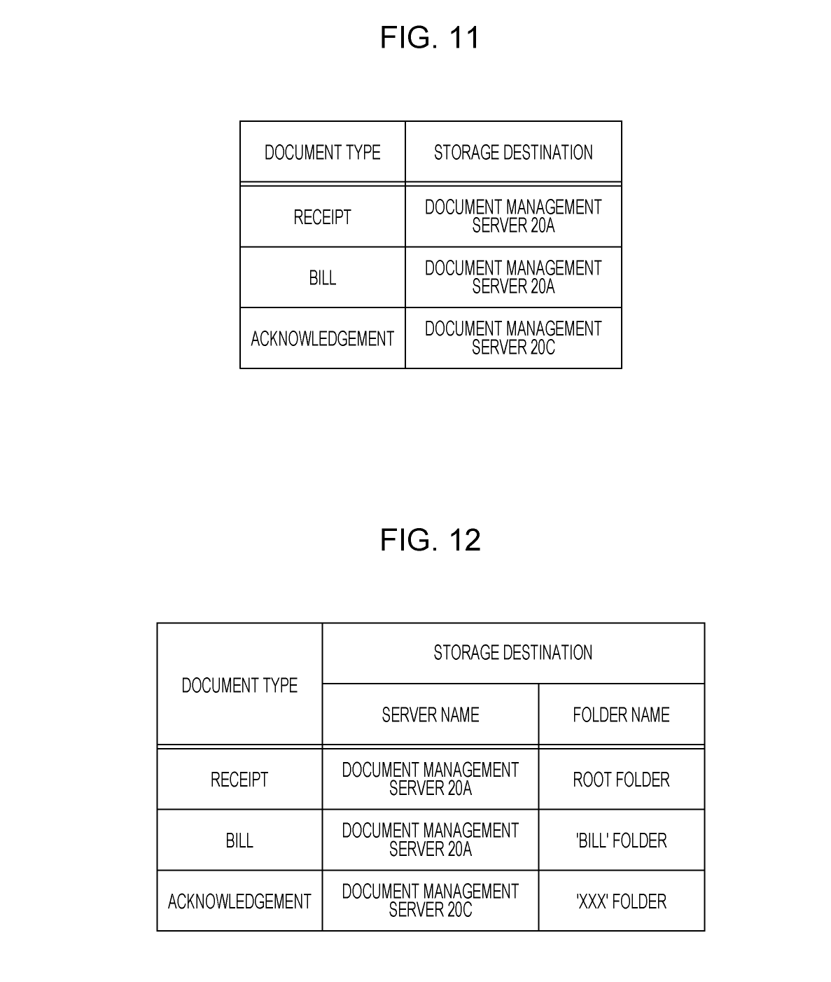

Examples of the storage destination information stored in the data storage part 34 of the document processing apparatus 11 in the document management system of this exemplary embodiment are described with reference to FIG. 11 and FIG. 12.

The exemplary storage destination information illustrated in FIG. 11 indicates a case in which the document management server 20A is set as a storage destination corresponding to a document type “receipt”, the document management server 20A is set as a storage destination corresponding to a document type “bill”, and the document management server 20C is set as a storage destination corresponding to a document type “acknowledgement”.

The exemplary storage destination information illustrated in FIG. 12 indicates a case in which not only external storage apparatuses of the storage destinations but also storage areas in the external storage apparatuses are set. Specifically, the exemplary storage destination information illustrated in FIG. 12 indicates a case in which a “root folder” of the document management server 20A is set as the storage destination corresponding to the document type “receipt”, a “‘bill’ folder” of the document management server 20A is set as the storage destination corresponding to the document type “bill”, and an “‘XXX’ folder” of the document management server 20C is set as the storage destination corresponding to the document type “acknowledgement”.

In this exemplary embodiment, the storage destination information is stored in advance in the data storage part 34 as a configuration file. The control part 32 refers to the storage destination information in the configuration file and stores an electronic document having attribute information added thereto in a storage destination that is set in advance without waiting for the user's specification.

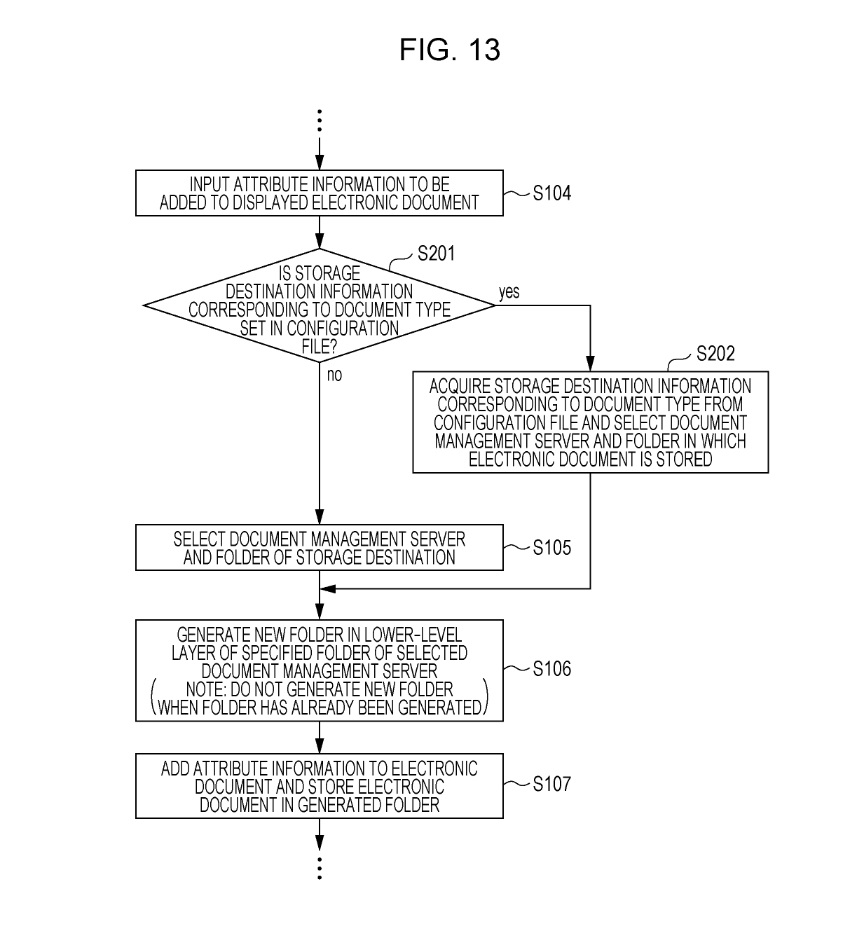

Next, processing in which the document processing apparatus 11 in the document management system of this exemplary embodiment acquires an electronic document file, adds attribute information, and then stores the electronic document file again in a specified storage area is described with reference to a flowchart of FIG. 13.

In the flowchart illustrated in FIG. 13, processing of Steps S201 and S202 is only added in the flowchart illustrated in FIG. 4 according to the first exemplary embodiment. Therefore, the added processing is only described.

When the user inputs attribute information to be added to a displayed electronic document (Step S104), the control part 32 determines whether storage destination information corresponding to the attribute information (document type in this case) is set in the configuration file stored in the data storage part 34 (Step S201).

When it is determined in Step S201 that the storage destination information corresponding to the attribute information is not set in the configuration file (“no” in Step S201), similarly to the first exemplary embodiment, the control part 32 causes the display part 33 to display the display screens illustrated in FIG. 6 and FIG. 7 for the user and also causes the operation receiving part 31 to receive selection of a document management server and a folder of the storage destination (Step S105).

When it is determined in Step S201 that the storage destination information corresponding to the attribute information is set in the configuration file (“yes” in Step S201), the control part 32 does not cause the display part 33 to display the display screens illustrated in FIG. 6 and FIG. 7 for the user but acquires the storage destination information corresponding to the document type from the configuration file and selects (determines) a document management server and a folder in which the electronic document is stored based on the document type of the attribute information to be added to the electronic document (Step S202).

The processing of Step S106 and the subsequent processing are similar to those of the first exemplary embodiment and description thereof is therefore omitted.

As described above, when the storage destination information in which a storage destination is set so as to correspond to attribute information is set in advance, the document processing apparatus 11 in the document management system of this exemplary embodiment stores the electronic document having the attribute information added thereto again in the storage destination determined based on the set storage destination information without inquiring the storage destination from the user.

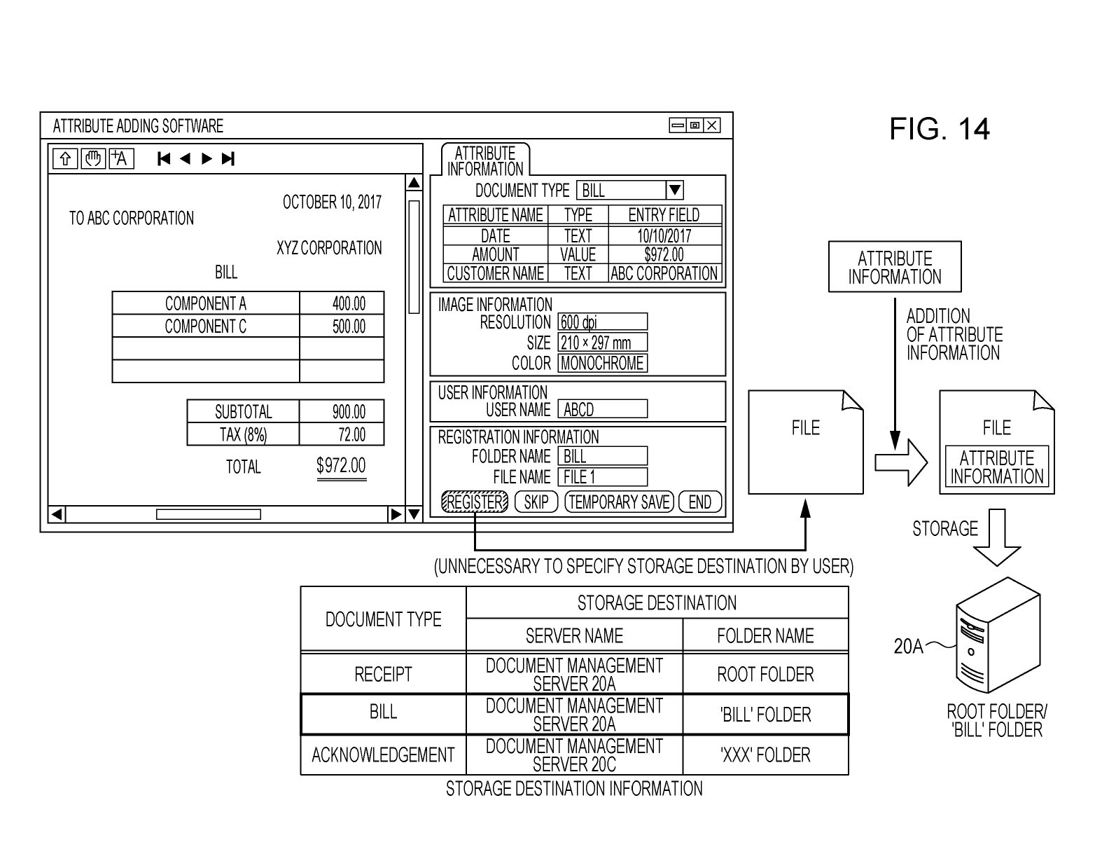

The processing to be performed when an electronic document is stored again in this manner is described with reference to FIG. 14.

FIG. 14 illustrates a state in which a storage destination is automatically determined based on storage destination information when the user uses the attribute adding software to display an electronic document, input character information as attribute information, and depress a “register” button.

That is, when the user depresses the “register” button of the attribute adding software, the document type of the attribute information to be added to the electronic document is “bill” and therefore the “document management server 20A” and the “‘bill’ folder” are automatically determined as the storage destination and the storage folder, respectively, by referring to the storage destination information.

After the attribute information is added to the electronic document, the electronic document is stored in the “‘bill’ folder” of the document management server 20A without the need for the user's specification of the storage destination.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document processing apparatus, comprising:
an acquisition unit that acquires an electronic document from an external storage apparatus;
an addition unit that adds attribute information to the electronic document acquired by the acquisition unit; and
a storage unit that stores the electronic document having the attribute information added thereto by the addition unit in a storage destination in the external storage apparatus.

2. The document processing apparatus according to claim 1, further comprising a reception unit that receives specification of the storage destination of the electronic document having the attribute information added thereto when character information to be added to the electronic document as the attribute information is input.

3. The document processing apparatus according to claim 1, wherein the storage unit stores the electronic document having the attribute information added thereto by the addition unit in a storage destination in an external storage apparatus specified based on storage destination information corresponding to the attribute information.

4. The document processing apparatus according to claim 3,
wherein the storage destination information includes information indicating an external storage apparatus of a storage destination and a storage area in the external storage apparatus, and
wherein the storage unit stores the electronic document having the attribute information added thereto by the addition unit in the specified storage area in the external storage apparatus of the storage destination.

5. The document processing apparatus according to claim 1, wherein an external storage apparatus of an acquisition source from which the electronic document is acquired by the acquisition unit is different from an external storage apparatus of a storage destination in which the electronic document is stored by the storage unit.

6. The document processing apparatus according to claim 1, wherein an external storage apparatus of an acquisition source from which the electronic document is acquired by the acquisition unit is identical to an external storage apparatus of a storage destination in which the electronic document is stored by the storage unit.

7. The document processing apparatus according to claim 6, wherein the storage unit stores the electronic document having the attribute information added thereto in a storage area different from a storage area from which the electronic document is acquired.

8. The document processing apparatus according to claim 7, wherein the storage unit generates a new storage area in a lower-level layer of the storage area from which the electronic document is acquired and stores the electronic document having the attribute information added thereto in the generated new storage area.

9. The document processing apparatus according to claim 7, wherein the storage unit generates a plurality of new storage areas corresponding to pieces of attribute information in a lower-level layer of the storage area from which the electronic document is acquired and stores the electronic document having the attribute information added thereto in any one storage area out of the plurality of generated new storage areas based on the added attribute information.

10. A non-transitory computer readable medium storing a program causing a computer to execute a process comprising:
acquiring an electronic document from an external storage apparatus;
adding attribute information to the acquired electronic document; and
storing the electronic document having the attribute information added thereto in a storage destination in the external storage apparatus.

11. A document processing apparatus, comprising:
acquisition means for acquiring an electronic document from an external storage apparatus;
addition means for adding attribute information to the electronic document acquired by the acquisition means; and
storage means for storing the electronic document having the attribute information added thereto by the addition means in a storage destination in the external storage apparatus.
